(19) United States
(12) Patent Application Publication
(10) Pub. No.: US 2003/0052199 A1
(43) Pub. Date: Mar. 20, 2003

(54) Spray nozzle

(75) Inventors: Hiroshi Ikeuchi, Hyogo (JP); Norio Onishi, Osaka (JP); Yoshiki Fujii, Hyogo (JP)

Correspondence Address: ARMSTRONG,WESTERMAN & HATTORI, LLP, 1725 K STREET, NW, SUITE 1000, WASHINGTON, DC, 20006, US

(73) Assignee: H. IKEUCHI & CO., LTD., Osaka-shi (JP)

(21) Appl. No.: 10/238,866

(22) Filed: Sep. 11, 2002

(30) Foreign Application Priority Data
Sep. 12, 2001 (JP) 2001-276665

(51) Int. Cl. B05B 1/14

(52) U.S. Cl. 239/550; 239/566; 239/575

(57) ABSTRACT

A spray nozzle has a nozzle tip removably installed on a main body of the spray nozzle at a spray side thereof. The nozzle tip has a flow path communicating a spray port disposed on a front-end surface with an inlet port disposed at a rear-end surface along an axis of the nozzle tip. A throat portion is provided on the flow path of the nozzle tip in a range from the inlet port to the spray port. The sectional configuration of the flow path in a range from the inlet port to the throat portion is circular or elliptic, and a sectional area of the flow path decreases gradually from the inlet port to the throat portion. The sectional configuration of the flow path in a range from the throat portion to the spray port changes from a circular configuration to an elliptic configuration or an elliptic configuration to a long circular configuration in such a way that the flow path in the range from the throat portion to the spray port is smoothly continuous, and a sectional area of the flow path from the throat portion to the spray port is constant or decreases gradually.

### BACKGROUND OF THE INVENTION

1. Field of the Invention

The present invention relates to a spray nozzle. More specifically, the present invention relates to a spray nozzle preferably used to remove scale in an iron manufacturing process, removing rust and paint on a ship, and cleaning a wire, a screen, and a felt with water. The present invention is intended to make a liquid-driving power uniform over an entire spray range, make a sprayed liquid thin, maintain a high liquid-driving power to thereby save water, and make a maintenance cycle long by improving wearability.

2. Description of the Related Art

A cleaning spray nozzle spraying a liquid at a spray pressure of 1.5-50 MPa is demanded to spray the liquid with a high driving power to enhance its detergency and save water and in addition spray the liquid with a uniform high driving power in an entire spray range. It is necessary to make the spray thin to spray the liquid with a high driving power. To do so, it is preferable to prevent the liquid to be supplied to a spray port from forming a turbulent flow and supply a laminar flow thereto and prevent the spray from being atomized after it is sprayed from the spray port. A uniform distribution of flow can be obtained by preventing generation of the turbulent flow.

The cleaning spray nozzle is further demanded to have a possible longest maintenance cycle. To do so, it is necessary to improve wear resistance. It is particularly necessary to suppress wear of an orifice of a nozzle tip to which a high load is applied. It is also necessary to suppress wear of the inner peripheral surface of a flow path of the nozzle tip to obtain a desired spray pattern reliably.

There is proposed a conventional cleaning spray nozzle having a nozzle tip 2 having a configuration shown in FIG. 16. In the nozzle tip 2, an edged projection 2d is formed at a position near the center of a flow path 2c communicating a inlet port 2a and a spray port 2b with each other to form an orifice 2f.

A cleaning spray nozzle spraying water at a spray pressure of 1.5-50 MPa disclosed in Japanese Patent Application Laid-Open No. 6-190429 has a check valve opened and closed by a liquid pressure.

As shown in FIG. 17, the supporting member 5 is fitted in the guide adapter 4 with the flow path formed between the guide adapter 4 and the supporting member 5, and an opening/closing piston valve 6 capable of making a reciprocating motion is inserted into the supporting member 5 and supported therein.

The valve-opening/closing high-pressure flow path 7 is connected to the downstream side of the opening/closing piston valve 6 inserted into the supporting member 5. When a high-pressure liquid flows into the valve-opening/closing high-pressure flow path 7, the opening/closing piston valve 6 is seated on a valve seat 8 and closes the flow path. When the valve-opening/closing high-pressure flow path 7 is depressurized, the opening/closing piston valve 6 moves away from the valve seat 8 to open the flow path.

As shown in FIG. 16 in the case where the orifice 2f is formed by providing the nozzle tip 2 with the projection 2d whose leading end projects sharply, the power of driving a spray jetted from the spray port 2b deteriorates outside a spray region. Thus it is impossible to obtain a uniform driving power over the entire spray range.

Because a water pressure is applied to the projection 2d, the edge of the projection 2d wears and thus the orifice 2f becomes large. Consequently the desired spray pattern cannot be obtained. That is, the spray becomes thick and the power of driving the spray becomes weak.

Further it is necessary to replace the nozzle tip because of the wear of the edge of the projection. Therefore the spray nozzle has a problem that the maintenance cycle is short and thus the cost is high and the suspension time period of a cleaning operation is long owing to the exchange of the nozzle tip.

It is necessary to provide the opening/closing valve-installed nozzle shown in FIG. 17 with the valve-opening/closing high-pressure flow path 7 to open and close the opening/closing piston valve 6 for the valve seat 8. It is also necessary to provide the opening/closing valve-installed nozzle with a mechanism for controlling the liquid pressure of the valve-opening/closing high-pressure flow path 7. Thus, it is a problem that the opening/closing valve-installed nozzle is complicated and large-scaled in its construction.

Further since the valve-opening/closing high-pressure flow path 7 penetrates through the guide adapter 4 and the body 9 and projects to the outside, the opening/closing valve-installed nozzle has low sealing performance and a complicated construction. Therefore troubles such as water leak is liable to occur.

At the downstream side, although the flow rectification member 3 rectifies the flow of the liquid inside the nozzle, it is necessary to rectify the liquid flow to some extent at the side upstream from the flow rectification member 3 to obtain sufficiently rectified flow. However, the flow path in the vicinity of the opening/closing piston valve 6 is the circuitous portion between the peripheral surface of the supporting member 5 and the inner peripheral surface of the guide adapter 4. Further the valve-opening/closing high-pressure flow path 7 may make the flow at the downstream side of the flow path in the vicinity of the opening/closing piston valve 6 turbulent. Thus sufficient flow rectification is not accomplished, and the nozzle is incapable of providing a reliable spray pattern. Therefore the opening/closing valve-installed nozzle shown in FIG. 17 is low in its cleaning performance at a high pressure.

### SUMMARY OF THE INVENTION

The present invention has been made in view of the above-described problems. It is a first object of the present invention to make a liquid-driving power uniform over an entire spray range, make a spray thin, maintain a high liquid-driving power, and make a maintenance cycle long.

It is a second object of the present invention to provide a spray nozzle having a check valve which opens and closes according to a liquid pressure without making a liquid turbulent, is superior in a flow rectification, is capable of spraying a liquid with a uniform liquid-driving power over an entire spray range by supplying a non-turbulent laminar flow to a spray port, has a simple construction, and is superior in maintenance performance, durability, and in sealing performance.

### SUMMARY OF THE INVENTION

To achieve the object, according to the present invention, there is provided a spray nozzle in which a flow path communicating a spray port disposed on a front-end surface of a nozzle tip with an inlet port disposed at a side opposite to the front-end surface is provided along an axis of the nozzle tip removably installed on a body of the spray nozzle at a spray side thereof. A throat portion is provided on the flow path of the nozzle tip in a range from the inlet port to the spray port. The sectional configuration of the flow path in a range from the inlet port to the throat portion is circular or elliptic, and a sectional area of the flow path decreases gradually from the inlet port to the throat portion. The sectional configuration of the flow path in a range from the throat portion to the spray port changes from a circular configuration or an elliptic configuration to the elliptic configuration or a long circular configuration, of which a pair of long side are straight line and a pair of short side are arc line in such a way that the flow path in the range from the throat portion to the spray port is smoothly continuous, and a sectional area of the flow path from the throat portion to the spray port is constant or decreases gradually. The ratio of a radius of curvature (R) of the throat portion to a diameter (d) of the flow path in the range of the throat portion is set to: R/d=0.2-5 in such a way that the flow path in the range of the throat portion is smoothly continuous.

As described above, in the sectional configuration of the spray nozzle of the present invention, the flow path of the nozzle tip is the elliptic configuration or the long circular configuration in its spray port, which is changed to the configuration of inlet port. The throat portion intermediate between the inlet port and the spray port does not have a sharp edge formed thereon but is formed as a surface smoothly continuous with the front and rear portions thereof. Thus it is possible to minimize the wear of the inner peripheral surface of the flow path. The sectional configuration of the flow path in the range from the throat portion to the spray port changes from the circular configuration or the elliptic configuration to the elliptic configuration or the long circular configuration in such a way that the flow path in the range from the throat portion to the spray port is smoothly continuous. The throat portion is not disposed in the vicinity of the spray port. That is, the spray nozzle is so constructed that the sprayed liquid spreads in a required region and does not collide with each other in the peripheral portion of the spray range. Therefore the liquid-driving power does not deteriorate in the peripheral portion of the spray range, but is uniform in the entire spray range. The construction of the spray nozzle allows the liquid-driving power to be uniform and high over the entirety of the spray pattern in the range of 100 mm-400 mm from the spray port.

The ratio of the radius of curvature (R) of the throat portion to the diameter (d) of the flow path in the range of the throat portion is set to: R/d=0.2-5. Thus it is possible to suppress generation of a turbulent flow along the peripheral wall of the flow path at the spray port side and keep the liquid flow laminar when the water has a high pressure, prevent the sprayed liquid from being atomized and colliding with each other. Thereby it is possible to spray the liquid with a uniform liquid-driving power. Further since the sectional configuration of the spray port is elliptic or long circular, it is possible to reliably maintain the desired thin spray pattern and make the liquid-driving power uniform and high in the entire spray pattern.

Since it is possible to make the liquid-driving power uniform and high in the entire spray pattern, it is possible to save water. Further because it is possible to minimize the wear of the inner peripheral surface of the flow path, it is possible to make the maintenance cycle long.

The ratio of the minor axis of the spray port to the major axis thereof is set to the range of 1:2 to 1:7 to make the spray jetted from the spray port thin and the liquid-driving power high. The ratio of the minor axis of the inlet port to the major axis thereof is set to he range of 1:1 to 1:3.

Supposing that the sectional area of the spray port is 1, the sectional area of the throat portion is 1-4.0 times larger than that of the spray port and the sectional area of the inlet port is 1.4-11 times larger than that of the spray port.

By setting the sectional area of the inlet port, the throat portion, and the spray port to the above-described ratio, it is possible to increase the pressure of the spray jetted from the elliptic spray port and the liquid-driving power. Thus the spray nozzle can be preferably used as a high-pressure cleaning nozzle.

A nozzle tip and an adapter are removably installed inside the body of the spray nozzle. A strainer is connected to the adapter in such a way that the axis of the nozzle tip, that of the adapter, and that of the strainer align with one another.

The housing of the strainer is open at one end thereof connected to the adapter and is closed at other end thereof to form a closed wall. A plurality of longitudinal grooves are circumferentially formed at regular intervals on the peripheral surface of the housing in the range from the closed wall thereof to a predetermined position of the peripheral surface thereof in such a way that a liquid flows into the housing from the longitudinal grooves.

The adapter accommodates a flow rectifier having a plurality of flow rectification plates partitioning a flow path inside the adapter connected to the strainer into a plurality of compartments.

It is preferable that the diameter of a flow path formed along the axis of the adapter decreases toward the nozzle tip.

The flow rectification plate is composed of a plurality of blades provided on a peripheral surface thereof in the range from a middle portion of a shaft disposed along the axis of the housing to an end thereof.

Owing to the provision of the flow rectification plate, water can be supplied to the nozzle tip as a laminar flow. Thus the flow path of the nozzle tip provides a spray pattern conforming to a designed spray pattern at a uniform distribution of flow rate.

According to the spray nozzle of the present invention, to allow a spray to be thin and driven with a high driving power, it is necessary to suppress generation of a turbulent flow and supply water to the flow path of the nozzle tip in the form of a laminar flow. By using the strainer having a high flow-rectifying function, it is possible to spray the water with a high driving power and save water.

In the spray nozzle having the nozzle tip, a strainer to which a liquid is supplied from a liquid supply pipe, a check valve opening and closing a flow path in dependence on a liquid pressure, an adapter incorporating a flow rectifier, and the nozzle tip are sequentially continuously arranged; and a flow path is formed continuously in the form of a straight pipe along the same axis in a range from the strainer disposed at a rear end of the spray nozzle to a spray port of the nozzle tip disposed at a front end thereof is provided.

The check valve has a hollow piston valve that is urged in a flow path-closing direction by a spring disposed along an inner peripheral surface of a cylinder, an opening/closing valve, for opening and closing a valve seat formed on the cylinder, disposed at a rear end of the piston valve at a liquid inflow side thereof, and an inflow opening formed at a position of a peripheral wall of the piston valve close to the opening/closing valve.

In this construction, when the opening/closing valve opens the valve seat according to a liquid pressure against an urging force of the spring, a liquid which has flowed into a space between the piston valve and the cylinder flows through the inflow opening and flows into a flow path composed of a hollow portion of the piston valve.

A flow rectifier is fitted in an inlet port of the adapter, and a comparatively long flow path is formed in a range from the flow rectifier to the inlet port of the nozzle tip.

The configuration of the nozzle tip is not limited to the above-described one in the construction of the check valve-provided spray nozzle in which the strainer to which a liquid is supplied from the liquid supply pipe, the check valve opening and closing the flow path in dependence on a liquid pressure, the adapter incorporating the flow rectifier, and the nozzle tip are sequentially continuously arranged; the nozzle tip and the adapter are removably installed inside a body of the spray nozzle; and the flow path is formed continuously in the form of a straight pipe along the same axis in the range from the strainer disposed at the rear end of the spray nozzle to the spray port of the nozzle tip disposed at the front end thereof.

In the strainer, the check valve, the adapter, and the nozzle tip of the check valve-provided spray nozzle, the flow path is formed continuously as a straight pipe along the same axis. Since the length of the flow path of the check valve and that of the adapter are long, it is possible to supply the nozzle tip with a straight laminar flow by preventing the liquid from generating a turbulent flow. Further since the flow rectifier is provided inside the adapter disposed downstream from the check valve, it is possible to improve a flow rectification operation much and jet a liquid at a uniform flow rate and with a high liquid-driving power over the entire spray range.

Further since the flow path is long and straight, the maintenance thereof can be accomplished efficiently, and wear resistance can be improved. Thus the flow path has a long life.

The check valve is urged in the direction in which the opening/closing valve of the piston valve closes the valve seat. In dependence on a supplied liquid pressure, the valve seat is opened by pressing down the piston valve against the urging force of the spring. This construction eliminates the need for a particular construction for opening and closing the valve. Thus the check valve has a simple construction.

By simplifying the construction, maintenance can be accomplished easily, and the generation percentage of trouble decreases. Hence it is possible to make the maintenance cycle long. Further since the check valve has a simple construction, it is easy to design and produce it and reduce the cost.

It is preferable that the diameter d₂ of the flow path inside the check valve and the diameter d₁ of the flow path inside the adapter are set to a relationship of 1≦d₂²/d₁²≦1.4.

It is possible to accelerate the flow rectification without reducing the liquid pressure by setting the relationship between the sectional area d₂² of the flow path of the check valve and the sectional area d₁² of the flow path of the adapter to the above relationship.

The ratio of the length L₁ of the flow path inside the adapter to the diameter d₁ of the flow path inside the adapter, namely, L₁/d₁ is set to 3-5. The ratio of the length L₂ of the flow path inside the check valve to the diameter d₂ of the flow path inside the check valve, namely, L₂/d₂ is also set to 3-5.

It is possible to accelerate the flow rectification without generating loss of the liquid pressure by making the flow path inside the check valve and the flow path inside the adapter comparatively long.

A supporting cylindrical portion for the spring is projected at a rear end of the inlet port of the adapter; the piston valve slides on an inner peripheral surface of the supporting cylindrical portion; and the flow rectifier is fitted at a front portion of the adapter continuous with the supporting cylindrical portion.

The piston valve is slidable on the inner peripheral surface of the supporting cylindrical portion serving as the means for receiving the spring, and a stepped portion is not formed. Thus it is possible to prevent generation of a turbulent flow.

Regarding the construction of the check valve, a spring receiving seat which projects radially outwardly and makes a close contact with an inner peripheral surface of the cylinder slidably is provided in the vicinity of a rear end of the piston valve at a liquid inflow side thereof; the spring receiving seat confronts a supporting cylindrical portion, for a spring, disposed on the adapter; the spring receiving seat supports one end of the spring, while the supporting cylindrical portion supports other end thereof. A tapered peripheral wall whose diameter decreases in such a way as to form a gap serving as a flow path between the tapered peripheral wall and the inner surface of the cylinder is formed rearward from the spring receiving seat, and an inflow opening is circumferentially formed at a certain interval spaced therebetween in such a way that the inflow opening is perpendicular to an axial direction of the flow path.

The spring urging the piston valve is interposed between the peripheral surface of the piston valve and the inner peripheral surface of the cylinder. The hollow portion of the piston valve becomes a flow path. Thus it is possible to dispose the flow path along the same axis of the nozzle and make the sectional area of the flow path large.

The opening/closing valve at the leading end of the piston valve is conic. The peripheral surface of the opening/closing valve contacts the valve seat of the cylinder bent in the shape of letter “L” at the liquid inlet side and separates therefrom. The diameter of the inner peripheral surface of a portion of the flow path disposed in a liquid inlet side with respect to the valve seat decreases gradually toward the valve seat.

As described above, since the opening/closing valve is conic and the valve seat is tapered in conformity to the inclination of the opening/closing valve, the opening/closing valve is urged by the spring when the valve seat is closed and makes a point contact with the valve seat. Thereby the spray nozzle has improved sealing performance when the opening/closing valve is closed.

It is preferable that the check valve is made of brass and the piston valve is made of stainless steel and the like; and the piston valve and the cylinder are made of different materials.

The flow rectifier interposed between a flow path inside the piston vale and a flow path inside the adapter has a flow path-partitioning plate.

Since the flow rectifier having the flow path-partitioning plate is disposed inside the adapter downstream from the piston valve of the check valve, it is possible to reliably rectify the flow of a liquid again after the liquid is rectified in the flow path of the piston valve.

By using the flow rectifier which divides the liquid flow by means of the flow rectification plate, it is possible to prevent mixing of the liquid (flow) by using a simple construction and allow the liquid to flow straight along the flow rectification plate.

The strainer disposed continuously with an inlet port of the check valve is composed of a rear end-closed long cylindrical body and has an inlet port disposed axially in such a way that the inlet port is spaced circumferentially at a certain interval therebetween. The strainer is installed on a water supply pipe in a direction perpendicular to an axial direction in such a way that the strainer projects inward into the water supply pipe, and a liquid which has flowed into an inner flow path from the inlet port flows toward the opening/closing valve disposed at a center of the check valve.

The strainer is installed on a water supply pipe in a direction perpendicular to an axial direction in such a way that the strainer is disposed alongside the water supply pipe and spaced at a certain interval.

As described above, according to the present invention, by sufficiently rectifying the liquid flowing inside the nozzle, it is possible to supply the liquid to the nozzle as a laminar flow without generating a turbulent flow. Thus the flow path of the nozzle tip provides a spray pattern conforming to a designed spray pattern at a uniform distribution of flow rate.

To allow a spray to be thin and driven with a high driving power, it is necessary to suppress generation of a turbulent flow and supply water to the flow path of the nozzle tip in the form of a laminar flow. Thus by enhancing the flow-rectifying function, it is possible to spray the water with a high driving power and save water.

In the case where the nozzle is provided with the check valve for automatically opening and closing the flow path in dependence on a supplied liquid pressure, it is possible to accomplish rectification of the liquid without generating a turbulent flow.

### BRIEF DESCRIPTION OF THE DRAWINGS

FIG. 1 is a sectional view showing a spray nozzle of a first embodiment of the present invention.

FIG. 2A is a perspective view showing a nozzle tip to be installed on the spray nozzle.

FIG. 2B is an exploded perspective view showing the nozzle tip to be installed on the spray nozzle.

FIG. 3A is a graph showing the area ratio of a flow path of the nozzle tip of the present invention.

FIG. 3B is a graph showing the area ratio of a flow path of a conventional nozzle tip.

FIG. 4 is a sectional view showing an adapter for use in the spray nozzle.

FIG. 5A is a front view showing a strainer for use in the spray nozzle.

FIG. 5B is a left side view showing the strainer for use in the spray nozzle.

FIG. 5C is a sectional view showing the strainer for use in the spray nozzle.

FIG. 6 is a perspective view showing a flow rectifier.

FIG. 7A shows a measuring method.

FIG. 7B shows results of measurement.

FIG. 8A shows a measuring method.

FIG. 8B shows results of measurement.

FIG. 9 is a sectional view showing a check valve-provided spray nozzle of a second embodiment of the present invention.

FIG. 10 is a sectional view showing the check valve-provided spray nozzle when a check valve opens.

FIG. 11 is an enlarged view showing main portions of the check valve.

FIG. 12 is an enlarged view showing main portions of a modification of the check valve.

FIG. 13 is a sectional view showing a check valve-provided spray nozzle having a nozzle tip of the modification.

FIGS. 14A, 14B, and 14C show various measuring methods.

FIG. 15 shows results of experiment.

FIG. 16 is a sectional view showing a prior art.

FIG. 17 is a sectional view showing another prior art.

### DETAILED DESCRIPTION OF THE PREFERRED EMBODIMENTS

The embodiments of the present invention will be described below with reference to drawings.

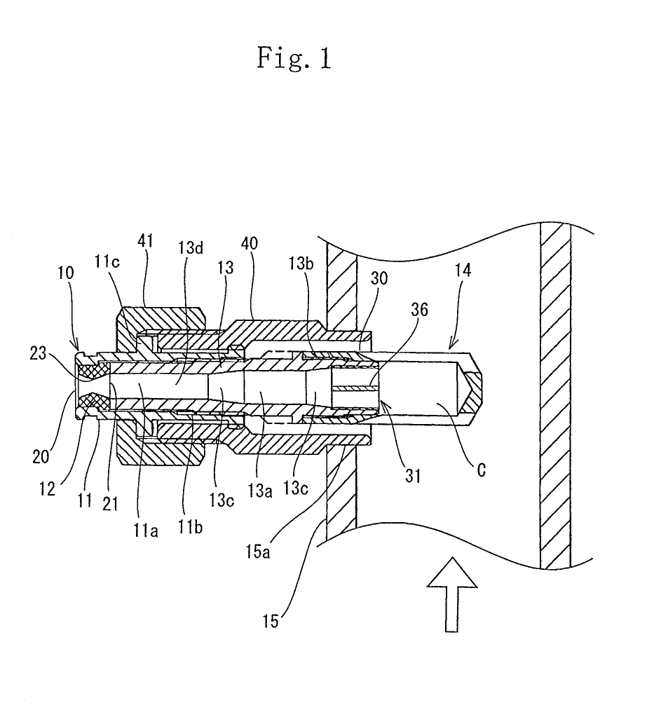

FIGS. 1 through 6 show a cleaning spray nozzle by spraying a liquid at a high pressure to remove scale according to a first embodiment of the present invention.

A high-pressure cleaning spray nozzle (hereinafter referred to as nozzle) 10 includes a main body 11, a nozzle tip 12 mounted on the main body 11 in such a way that the nozzle tip 12 is disposed at the front (left-hand side in FIG. 1) end of a liquid spray side, an adapter 13 disposed adjacent to the nozzle tip 12 inside the main body 11, and a strainer 14 connected with the adapter 13.

The nozzle 10 is mounted on a water supply pipe 15 at a predetermined interval spaced therebetween. An outer pipe 40 is welded to the periphery of each installing opening 15a formed on the peripheral wall of the water supply pipe 15 in such a way that the outer pipe 40 projects from the installing opening 15a. An installing member 41 is installed at an end of the outer pipe 40 with a screw.

In mounting the nozzle 10 on the water supply pipe 15, the strainer 14 and the adapter 13 are inserted into the outer pipe 40. With a flange 11c projecting from the peripheral surface of the main body 11 in contact with an end surface of the outer pipe 40 and with the flange 11c sandwiched between an end 41a of the installing member 41 and the end surface of the outer pipe 40, the installing member 41 is installed on the outer pipe 40 with the screw. In this state, the strainer 14 is disposed inside the water supply pipe 15, the adapter 13 is disposed inside the outer pipe 40, and the front side of the main body 11 projects forward (left-hand side in FIG. 1) beyond the installing member 41.

The main body 11 is approximately cylindrical. The nozzle tip 12 is fitted in the main body 11 at its front end along a flow path formed axially and connected with the adapter 13 with a screw.

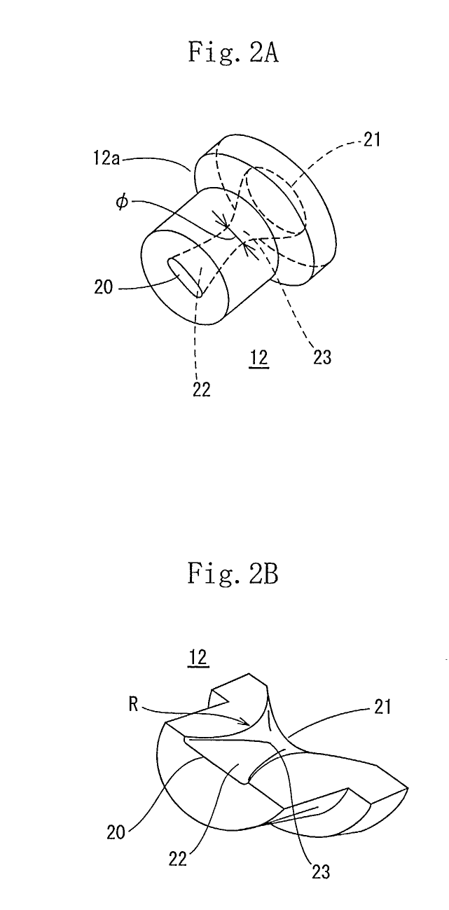

The nozzle tip 12 has a configuration, as shown in FIG. 2. The nozzle tip 12 is composed of two molded half parts divided in the axial direction thereof. The two half parts are integrated with each other by sintering, with to-be-connected surfaces thereof butted against each other to form the cylindrical nozzle tip 12.

The nozzle tip 12 has a large-diameter portion at one end thereof. A peripheral surface 12a of the large-diameter portion is coincident with the spray-side inner peripheral surface of the main body 11. A throat portion 23 formed on a flow path 22 along the axis of the nozzle tip 12 is disposed intermediate between a spray port 20 disposed on a front-end surface of the nozzle tip 12 and an inlet port 21 disposed at the side opposite to the front-end surface of the nozzle tip 12.

The flow path 22 is sectionally elliptic in the range from the inlet port 21 to the throat portion 23, sectionally circular at the position of the throat portion 23, sectionally elliptic from the throat portion 23 toward the spray port 20, and sectionally elliptic or long circular at the spray port 20. A long circular configuration has a pair of a long straight line side and a pair of a short are side. In this manner, the flow path is smoothly continuously formed from the inlet port 21 to the spray port 20.

The sectional area of the flow path 22 decreases gradually from the inlet port 21 to the throat portion 23 and is uniform or gradually decreases from the throat portion 23 to the spray port 20.

More specifically, supposing that the sectional area of the spray port 20 is 1, the sectional area of the throat portion 23 is 1-4.0 times larger than that of the spray port 20 and the sectional area of the inlet port 21 is 1.4-11 times larger than that of the spray port 20.

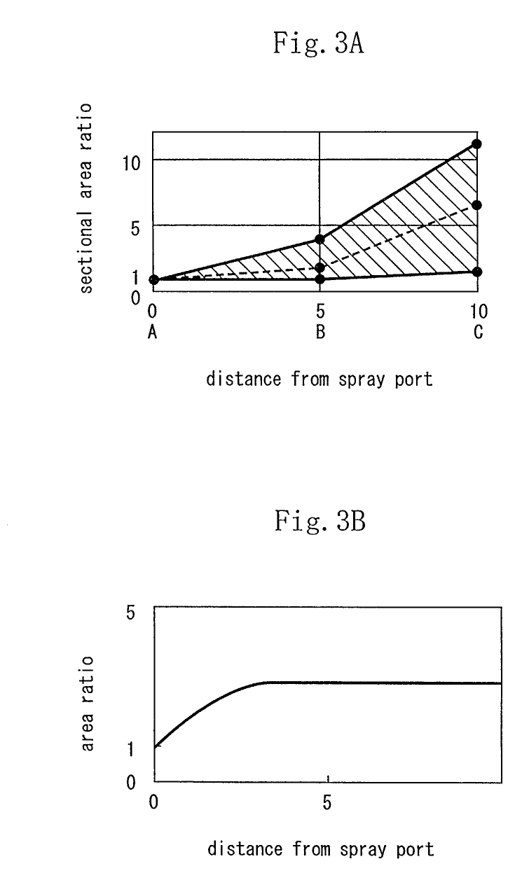

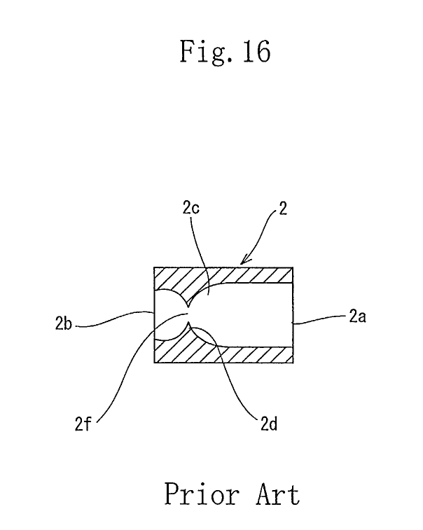

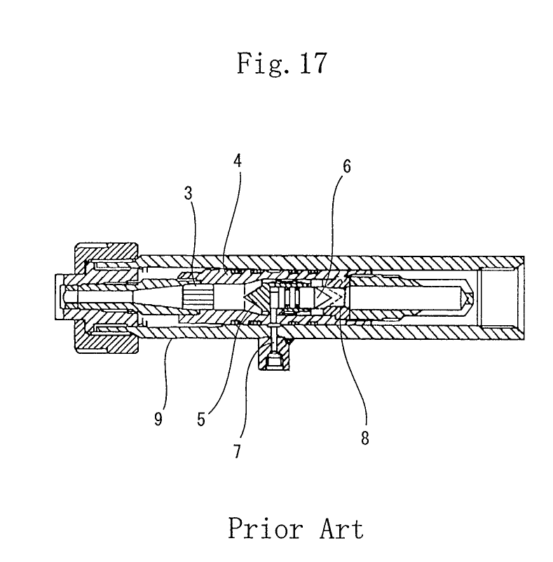

FIG. 3A shows the ratio of the sectional area of each position of the flow path 22 to that of the spray port 20 in the range from the spray port 20 to the inlet port 21. For comparison, FIG. 3B shows the ratio of the sectional area ratio in the conventional nozzle tip shown in FIG. 16.

As apparent from the table, the nozzle tip of the spray nozzle of the present invention is much different from the conventional nozzle tip in that the ratio of the sectional area is reduced in the range from the inlet port 21 (point C) to the spray port (point A) and in particular from the inlet port 21 (point C) to the throat portion (point B) placed at the central position in the axial direction of the nozzle tip.

The ratio of the minor diameter of the spray port 20 to the major diameter thereof is set to the range of 1:2 to 1:7. In the first embodiment, the major diameter is set to 7.6 mm, and the minor diameter is set to 1.5 mm.

A sharp edge is not formed on the inner peripheral surface of the throat portion 23 where the sectional configuration of the flow path 22 changes from the circular configuration to the elliptic configuration, but the inner peripheral surface of the throat portion 23 is deformed smoothly. That is, an orifice having an edge is not formed on the flow path 22, unlike the conventional art.

More specifically, the radius of curvature (R) of the throat portion 23 with respect to the diameter (d) of the flow path 22 is set to the following range:

R/d=0.2-1.5.

The above-described configuration of the flow path 22 of the nozzle tip 12 allows the liquid-driving power to be uniform and high over the entirety of a spray pattern in the range of 100 mm-400 mm from the spray port 20. That is, the liquid-driving power in the peripheral region of the spray pattern is equal to that in the central region thereof.

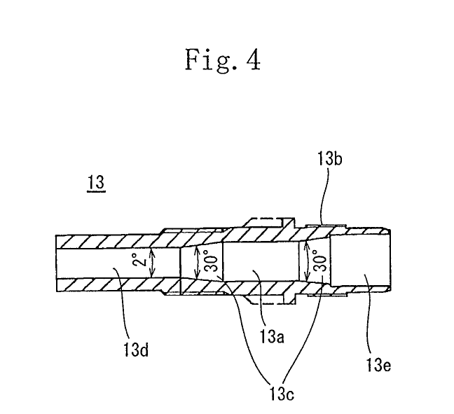

With reference to FIG. 4 in particular, the adapter 13 is approximately cylindrical and has a flow path 13a extending axially. A screw 13b formed on the peripheral surface of an end side of the adapter 13 at its upstream side is tightened into an end of the housing 30 of the strainer 14 at its downstream side to connect the adapter 13 and the strainer 14 to each other. The diameter of the flow path 13a decreases from a portion 13c where the adapter 13 and the housing 30 are connected to each other to a portion 13d where the adapter 13 and the main body 11 are connected to each other. More specifically, the portion 13c has a larger angle (30° in the first embodiment), and the range from the portion 13c to the portion 13d has a smaller angle (2° in the first embodiment).

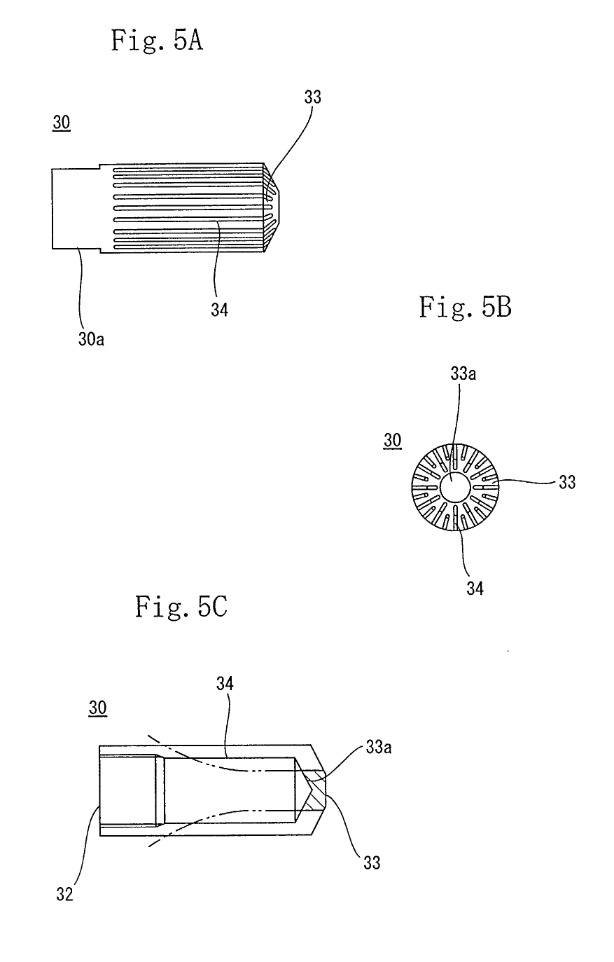

With reference to FIG. 5 in particular, the strainer 14 has the housing 30 approximately cylindrical. The housing 30 has an opening 32 at the side where the adapter 13 and the housing 30 are connected to each other. The housing 30 has also a closed wall 33 at the opposite side. The central portion of the closed wall 33 is projected outward to form a V-shaped concavity 33a inside the strainer 14. A plurality of long and narrow longitudinal grooves 34 are circumferentially formed at regular intervals on the housing 30 from a certain position of the peripheral surface of the closed wall 33 to a peripheral surface 30a of the housing 30. In the first embodiment, 24 longitudinal grooves 34 each having a width of 1.1 mm are arranged at intervals of 15°. The longitudinal grooves 34 disposed on the closed wall 33 incline at an acute angle. The strainer 14 is disposed inside the water supply pipe 15 to flow water into the housing 30 through the longitudinal groove 34.

A flow rectifier 31 accommodated in the adapter 13 has an outer cylinder 37 fitted on the inner surface of the adapter 13. The outer cylinder 37 accommodates a plurality of flow rectification plates 36 radially projecting from the axis 35.

In the first embodiment, the flow rectifier 31 has six flow rectification plates 36 spaced at 60°. However, the number of the flow rectification plates 36 is not limited to six.

As shown in FIG. 1, the spray nozzle 10 having the above-described construction is mounted on the water supply pipe 15. From the longitudinal grooves 34, water flows into the housing 30 of the strainer 14 inserted into the water supply pipe 15. Then the water flows from the housing 30 to the gaps between the flow rectification plates 36 of the flow rectifier 31 mounted on the adapter 13 and is rectified as a laminar flow by the flow rectification plates 36. Then the flow-rectified water flows into the flow path 13a of the adapter 13, with the water being rectified by the flow rectification plates 36. Thus the water which has flowed out from the flow rectifier 31 arrives at the inlet port 21 of the nozzle tip 12 without generating a turbulent flow. At this time, the water does not generate a turbulent flow but remains rectified because the flow path 13a of the adapter 13 is tapered gradually.

The water which has flowed into the inlet port 21 of the nozzle tip 12, with the water keeping the flow-rectified state decreases gradually in its sectional area in the range from the inlet port 21 to the throat portion 23. Thus the water having a high pressure flows into the throat portion 23. Thereafter the water flows toward the elliptic or long circular spray port 20, with the water flattening or becoming thin and is sprayed from the spray port 20.

The throat portion 23 of the nozzle tip 12 is not provided with a sharp edge, but smoothly continuous with the front and rear portions of the flow path. Thus the inner surface of the flow path is not locally worn.

Since the water is collected in the throat portion 23 and then flows to the elliptic or long circular spray port 20, with the water being flattened, the water does not generate a turbulent flow along the peripheral wall of the spray port 20 but is sprayed as a laminar flow and not atomized after the water is sprayed from the spray port 20. Therefore it is possible to maintain the pattern of the spray jetted from the spray port 20 in a predetermined pattern and make the flow rate in the spray pattern uniform. Thus it is possible to allow the liquid-driving power to be uniform over the entire spray pattern. That is, the liquid-driving power in the peripheral region of the spray pattern is equal to that in the central region thereof. More specifically, the liquid-driving power is uniform and high over the entirety of the spray pattern in the range of 100 mm-400 mm from the spray port 20.

Further the water supplied by the flow rectifier 31 to the main body 11 does not generate a turbulent flow and is rectified in its flow. Therefore it is possible to prevent the spray jetted from the long and narrow spray port 20 from generating the turbulent flow, keep the spray thin, and drive the spray with a high power. Consequently it is possible to save water.

The distribution of the liquid-driving power, the thickness of the spray, and the strength of the liquid-driving power were measured on the case where a liquid was sprayed by using the spray nozzle 10 of the first embodiment and on the case where a liquid was sprayed by using the spray nozzle shown in FIG. 16.

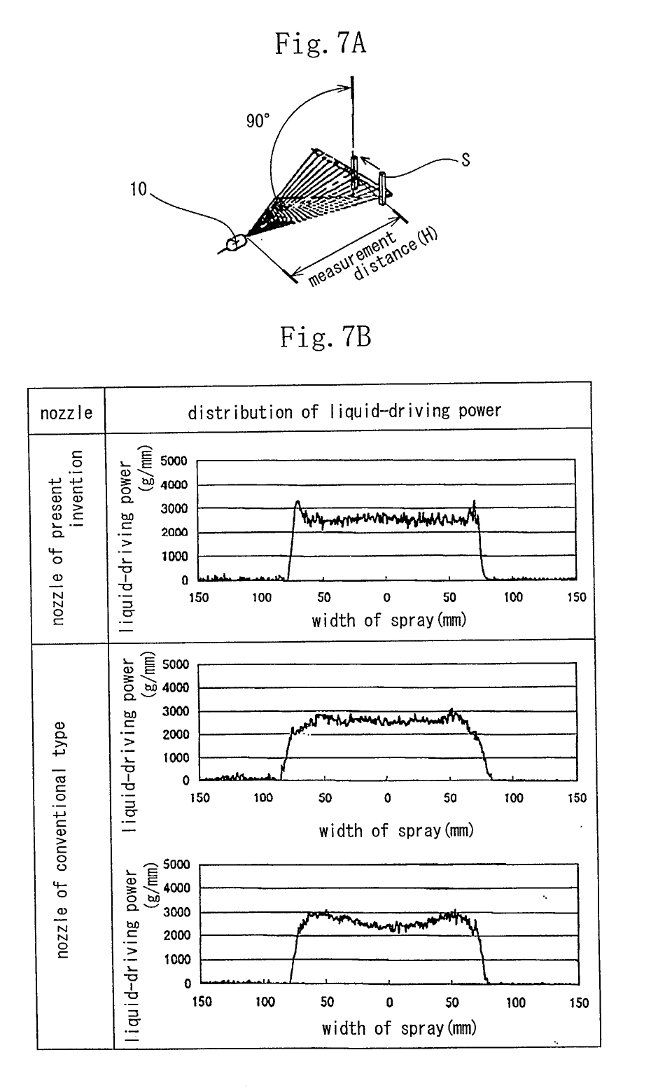

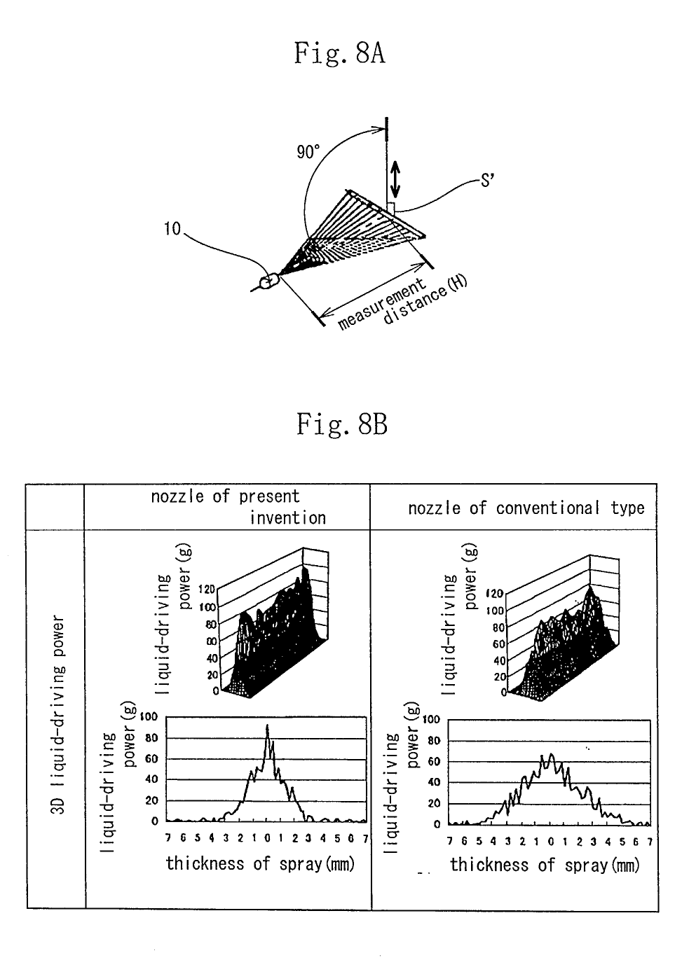

As the method of measuring the distribution of the liquid-driving power, as shown in FIG. 7A, a sensor S was movably disposed at a distance of L (100-400 mm) from the spray port of the spray nozzle 10 to measure a liquid-driving power. As shown in FIG. 8A, the relationship between the thickness of the spray and the liquid-driving power was measured by vertically moving a sensor S′ directly below the spray port.

The spray pressure at the time of the measurement was 2.0 MPa, and the spray amount was 7.11 liters/minute.

FIG. 7B shows results of the measurement of the distribution of the liquid-driving power in the measuring test shown in FIG. 7A. In the case of the spray nozzle 10 of the present invention, the liquid-driving power was uniform in the entire region of the spray width, and the liquid-driving power at both sides was high. That is, it was confirmed that the liquid-driving power does not deteriorate in the peripheral region of the spray pattern. On the other hand, in the case of the conventional spray nozzle including the orifice having the edge formed thereon, there were portions at both sides where the liquid-driving power was weak. In the case of the conventional spray nozzle, the edge of the throat portion was worn during a long use. Thus the edge portions of the spray was liable to wear, the liquid-driving power was weak at both sides, and the spray region became narrow. Thus the liquid-driving power at the overlapping portion became weaker.

FIG. 8B shows results of the relationship between the thickness of the spray and the liquid-driving power in the measuring test shown in FIG. 8A.

As shown in FIG. 8B, it was confirmed that in the spray nozzle of the present invention, the spray is thin and its liquid-driving power is high and that in the conventional type shown in FIG. 16, the spray is thick and its liquid-driving power is low.

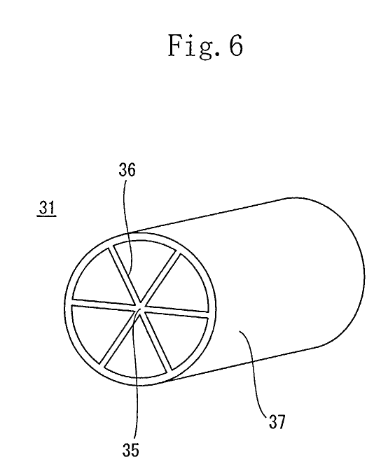

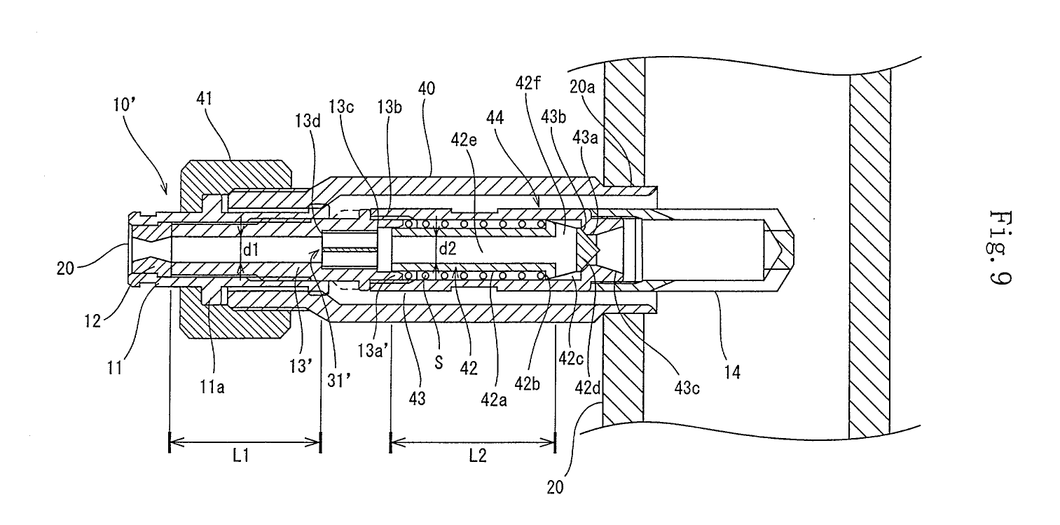

FIGS. 9 through 12 show a cleaning spray nozzle provided a high-pressure check valve (hereinafter referred to as nozzle) 10′ according to a second embodiment of the present invention. The nozzle tip 12, the strainer 14, and the flow rectifier 31 of the second embodiment are identical to the nozzle tip (shown in FIG. 2), the strainer (shown in FIG. 5), and the flow rectifier (shown in FIG. 6) of the first embodiment respectively in the configuration thereof.

As shown in FIG. 9, a nozzle 10′ has a main body 11′, the nozzle tip 12 that is mounted inside the main body 11′ at an end of the spray side, an adapter 13′ connected with the main body 11′ at its liquid inlet side, a flow rectifier 31′ fitted in the adapter 13′, a check valve 40 interposed between the adapter 13′ and the strainer 15.

The strainer 14, a check valve 44, an adapter 13′ incorporating the flow rectifier 31 therein, and the nozzle tip 12 are sequentially continuously arranged to form a flow path continuously in the form of a straight pipe a long the same axis in the range from the strainer 14 to the spray port 20 of the nozzle tip 12.

Similarly to the first embodiment, the nozzle 10′ is inserted into the outer pipe 40 projecting from the peripheral wall of the water supply pipe 15. Then strainer 14 is disposed inside the water supply pipe 15. Thereafter the nozzle 10′ is installed on the outer pipe 40 with a screw of the installing member 41.

In the check valve 44, a cylinder 43 is fixed between the adapter 13′ and the strainer 14, a spring S is disposed along the inner peripheral surface of the cylinder 43, and a hollow piston valve 42 urged by the spring S in a closing direction of the flow path is disposed inward from the spring S. The spring S expands and contracts in dependence on a liquid pressure, thus opening and closing the flow path automatically.

Describing the construction of the piston valve 42 specifically, a spring receiving seat 42b which projects radially outwardly and slidably makes a close contact with the inner peripheral surface of the cylinder 43 is provided in the rear of a straight pipe portion 42a. Formed in the rear of the spring receiving seat 42b is a tapered peripheral wall 42c whose diameter decreases in such a way as to form a gap C serving as the flow path between the tapered peripheral wall 42c and the inner surface of the cylinder 43. A conic opening/closing valve 42d is formed at an end of the tapered peripheral wall 42c.

Inflow openings 42f communicating with the flow path 42e disposed inside the straight pipe portion 42a are circumferentially formed at a certain interval therebetween at peripheral wall 42c in such a way that the inflow openings 42f are perpendicular to the axial direction of the flow path.

The cylinder 43 is bent in the shape of a letter “L” at the liquid inlet side to form a valve seat 43a on a bent portion. The valve seat 43a has an inclined surface 43b formed at a portion thereof which contacts the opening/closing valve 42d of the piston valve 42 and separates therefrom. A tapered inlet port 43c communicating with the strainer 14 is formed in the range from the valve seat 43a to an end of the cylinder 43 at the liquid inflow side.

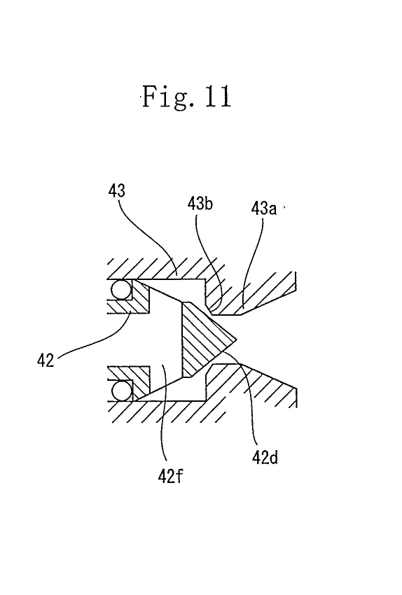

As shown in FIG. 11, the inclination of the peripheral surface of the opening/closing valve 42d is different from that of the inclined surface 43b of the valve seat 43a so that the opening/closing valve 42d and the valve seat 43a make not a surface contact but a point contact. Thereby the spray nozzle 10′ has improved sealing performance when the opening/closing valve 42d is closed.

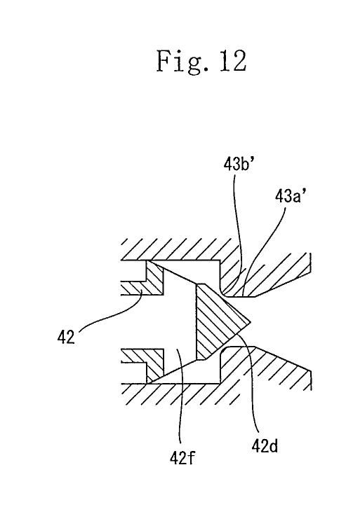

In a modification of the valve seat 43a′ shown in FIG. 12, the portion of the valve seat 43a′ which contacts the opening/closing valve 42d is formed as a curved surface 43b′. This construction is also capable of securing sufficient sealing performance.

The piston valve 42 constituting the opening/closing valve 42d and the cylinder 43 constituting the valve seat 43a are made of different materials whose hardness is different from each other. Thus the opening/closing valve 42d and the inclined surface 43b of the valve seat 43a contact closely, thereby improving the sealing performance.

In the second embodiment, the piston valve 42 is made of stainless steel, and the cylinder 43 is made of brass.

As the portion for receiving the front side of the spring S, a supporting cylindrical portion 13a′ is projected at the rear (upstream) side of the inlet port of the adapter 13′, with a stepped portion 13c′ formed on the adapter 13′. Thus the supporting cylindrical portion 13a′ confronts the spring receiving seat 42b formed on the piston valve 42. Thereby the spring receiving seat 42b supports one end of the long spring S, while the supporting cylindrical portion 13a′ supports the other end thereof.

The piston valve 42 slides on the inner peripheral surface of the supporting cylindrical portion 13a′. The flow rectifier 31′ is fitted in the adapter 13′ continuous with the supporting cylindrical portion 13a′. As shown in FIG. 6, the flow rectifier 31 has the flow rectification plates 36 partitioning the flow path into a plurality of compartments.

The flow path in the range from the flow rectifier 31 fitted in the adapter 13′ at its inlet side to the inlet port of the nozzle tip 12 is comparatively long.

There is the following relationship between the diameter d₂ of the flow path (diameter of the flow path 42e of the piston valve 42) inside the check valve 44 and the diameter d₁ of the flow path inside the adapter 13′:

1≦d₂²/d₁²≦1.4

The ratio of the length L₁ of the flow path inside the adapter 13′ to the diameter d₁ of the flow path inside the adapter 13′, namely, L₁/d₁ is set to 3-5. The ratio of the length L₂ of the flow path 42e inside the check valve 44 to the diameter d₂ Of the flow path 42e inside the check valve 44, namely, L₂/d₂ is also set to 3-5.

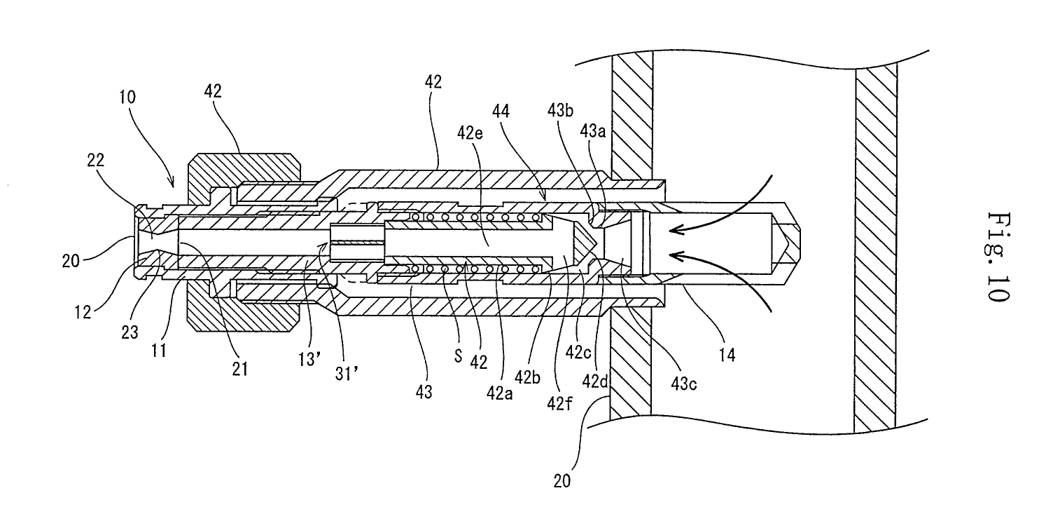

As shown in FIG. 9, the check valve-provided nozzle 10′ is mounted on the water supply pipe 15. From a large number of the longitudinal grooves 34, water flows into the strainer 14 inserted into the water supply pipe 15. The water flows from the strainer 14 to the inlet port 43c of the cylinder 4.3 of the check valve 44. As shown in FIG. 10, owing to a pressure of the water, the piston valve 42 is pressed to the stepped portion 13c′ of the adapter 13′ against the urging force of the spring S. Thereby the opening/closing valve 42d is moved away from the valve seat 43a to open the flow path.

When a load of 7 kgf/cm² is applied to the spring S, the opening/closing valve 42d is opened. In the second embodiment, the liquid pressure supplied from the water supply pipe 15 at the time of a spray time is set to the range of 100-500 kgf/cm² to open the opening/closing valve 42d instantaneously.

Water which has passed the valve seat 43a flows into the space C between the inner peripheral surface of the cylinder 43 and the tapered peripheral wall 42c of the piston valve 42. Then the water flows from the inflow opening 42f into the flow path 42e inside the piston valve 42.

Since the flow path 42e inside the piston valve 42 is long and straight, it is possible to form a liquid flow having a high linearity and hence a high flow-rectifying effect. This construction accelerates rectification of the liquid flow. Thus the flow path 42e does not generate vibrations that will occur when a turbulent flow is generated, thus improving the sealing performance.

The water rectified in a laminar flow in the piston valve 42 flows into the flow rectifier 31 inside the adapter 13′. The water flows through the flow rectifier 31, with the water being further rectified in its flow by the flow rectification plate 36. Thereafter the water reaches the inlet port 21 of the nozzle tip 12, with the water being still rectified in its flow without generating a turbulent flow.

The water which has flowed into the inlet port 21 of the nozzle tip 12, with the water keeping the flow-rectified state decreases gradually in its sectional area in the range from the inlet port 21 to the throat portion 23. Thus the water having a high pressure flows into the throat portion 23. Thereafter the water flows toward the elliptic or long circular spray port 20, with the water flattening or becoming thin and sprayed from the spray port 20.

The throat portion 23 of the nozzle tip 12 is not provided with a sharp edge, but smoothly continuous with the front and rear portions of the flow path like the first embodiment. Thus the inner surface of the flow path is not locally worn. Since the water is collected in the throat portion 23 and then flows to the elliptic spray port 20, with the water being flattened, the water does not generate a turbulent flow along the peripheral wall of the spray port 20 but is sprayed as a laminar flow and not atomized after the water is sprayed from the spray port 20. Therefore it is possible to maintain the pattern of the spray jetted from the spray port 20 in a predetermined pattern and make the flow rate in the spray pattern uniform. Thus it is possible to allow the liquid-driving power to be uniform over the entire spray pattern. That is, the liquid-driving power in the peripheral region of the spray pattern is equal to that in the central region thereof. More specifically, the liquid-driving power is uniform and high over the entirety of the spray pattern in the range of 100 mm-400 mm from the spray port 20.

In the check valve 44, since the hollow portion of the hollow piston valve 42 is formed as the flow path 42e, the flow path can be formed along the axis of the piston valve 42. Since the water flow is supplied to the main body 11′ as a rectified flow without generating a turbulent flow, it is possible to jet a spray from the long and narrow nozzle tip 12 without generating a turbulent flow, keep the spray thin, and make the liquid-driving power high. Consequently water can be saved.

It is unnecessary to provide the check valve 44 with a particular valve-opening/closing construction unlike the conventional one. The spring S allows the check valve 44 to have a simple construction. Thus the check valve 44 can be maintained easily, and the generation percentage of trouble decreases. Hence it is possible to make the maintenance cycle long. Further since the check valve 44 has a simple construction, it is easy to design and produce it and reduce the cost.

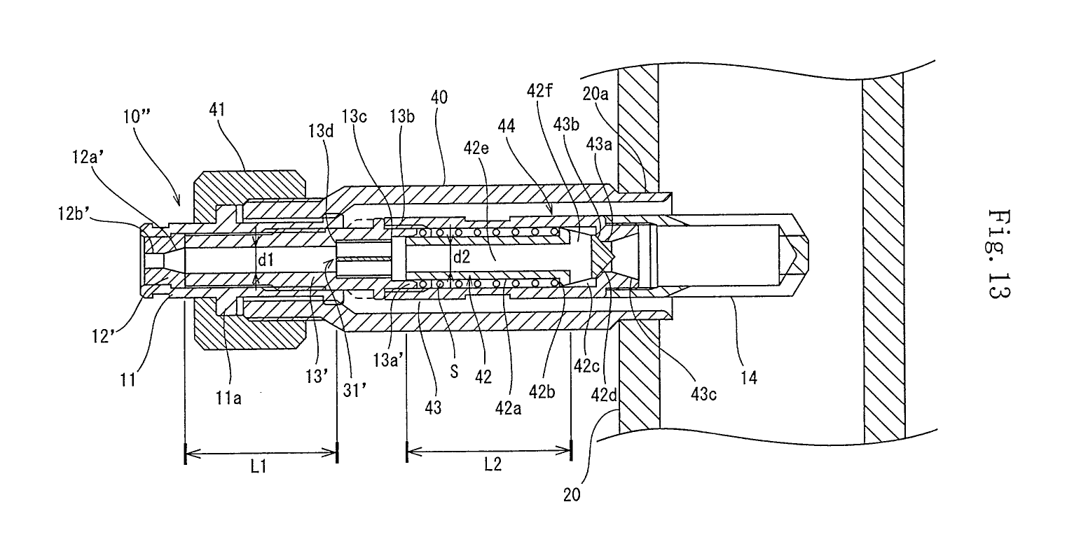

FIG. 13 shows a modification of the check valve-provided spray nozzle 10′ of the second embodiment.

A nozzle tip 12′ of a check valve-provided spray nozzle 10″ is different from that of the check valve-provided spray nozzle 10′. The nozzle tip 12′ has a diameter-reduced portion 12a′, tapering toward the spray side, serving as a flow path extending along the axis thereof and a cylindrical portion 12b′ straight and continuous with the diameter-reduced portion 12a′.

Other constructions of the check valve-provided spray nozzle 10″ are similar to those of the check valve-provided spray nozzle 10′ of the second embodiment. Thus description thereof is omitted herein.

The distribution of the liquid-driving power, the erosion, and the strength of the local liquid-driving power were measured on the case where a liquid was sprayed by using the check valve-provided spray nozzle 10′ of the second embodiment and on the case where a liquid was sprayed by using the spray nozzle shown in FIG. 16.

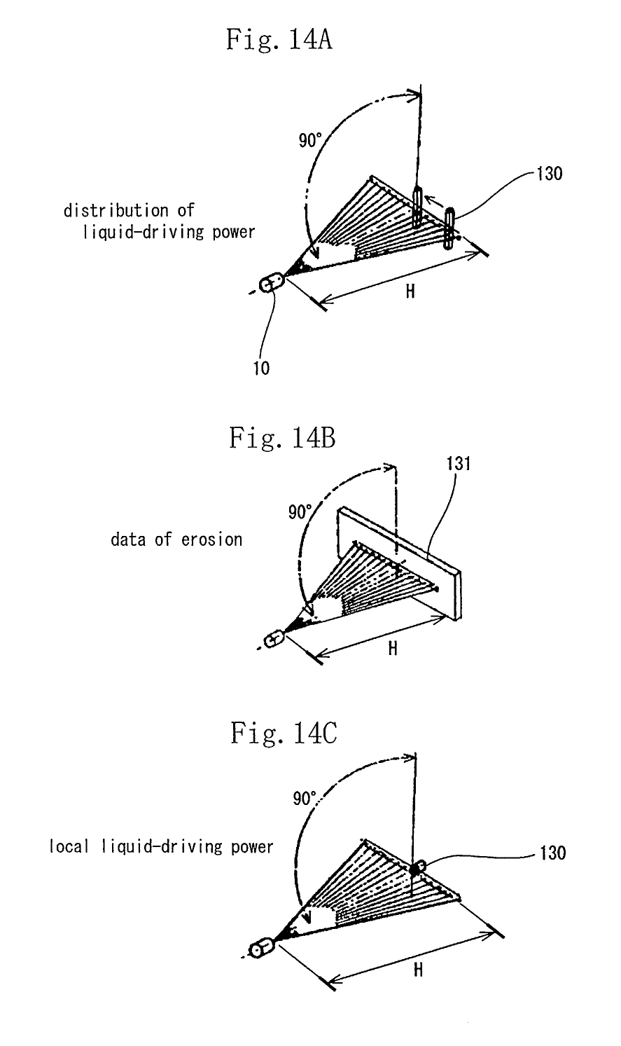

As the method of measuring the distribution of the liquid-driving power, as shown in FIG. 14A, a sensor 130 was movably disposed at a measuring distance H of 200 mm from the spray port of the spray nozzle 10′ to measure a liquid-driving power.

As the method of measuring the erosion, a spray jetted from the spray nozzle collided with a lead plate 131, having a thickness of 5 mm, spaced at the distance H from the spray port.

As the method of measuring the local liquid-driving power, the sensor 130 was spaced at the distance H from the spray port, with the sensor 130 disposed at the center of a spray.

The spray pressure at the time of the measurement was 15 MPa, and the spray amount was 104 L/minute.

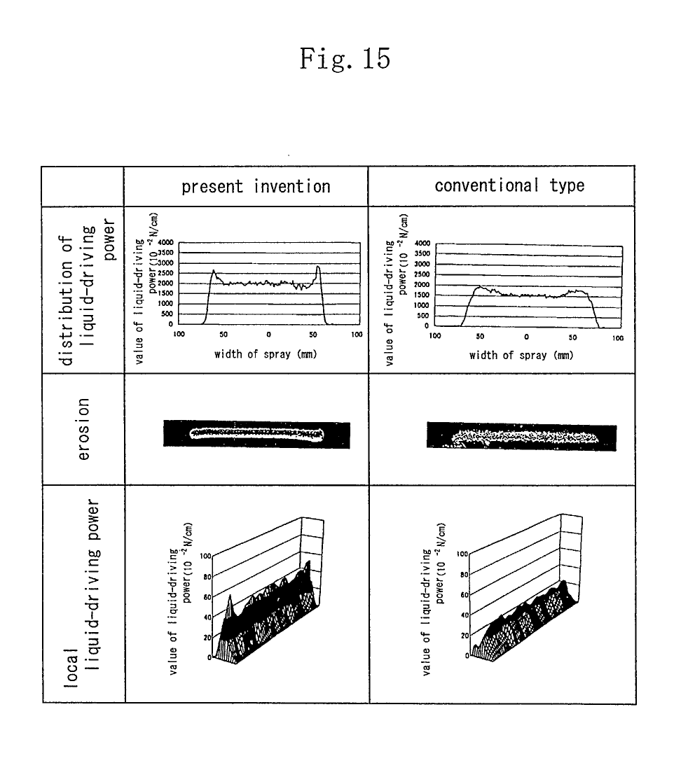

FIG. 15 shows results of the measurement made by carrying out each measuring method shown in FIG. 14.

Regarding the liquid-driving power, in the case of the spray nozzle 10′ of the present invention, the liquid-driving power was uniform in the entire region of the spray width, and the liquid-driving power at both sides was high. That is, it was confirmed that the liquid-driving power does not deteriorate in the peripheral region of the spray pattern. On the other hand, in the case of the conventional type, there were portions at both sides where the liquid-driving power was weak.

Regarding the erosion, in the case of the spray nozzle 10′ of the present invention, the erosion depth was 2.7-3.0 mm, the erosion width was 128 mm, and erosion thickness was 8 mm. In the case of the conventional type, the erosion depth was 0.9-1.5 mm, the erosion width was 135 mm, and erosion thickness was 8 mm. It was confirmed that the spray nozzle 10′ of the present invention can accomplish the erosion stronger than the conventional spray nozzle.

Regarding the local liquid-driving power, in the case of the spray nozzle 10′ of the present invention, the maximum local liquid-driving power was 0.63N, and the minimum local liquid-driving power was 0.36N. In the case of the conventional type, the maximum local liquid-driving power was 0.31N, and the minimum local liquid-driving power was 0.22N. It was confirmed that the spray nozzle 10′ of the present invention had larger maximum local liquid-driving power and the minimum local liquid-driving power. Thus the spray nozzle of the present invention provides a higher liquid-driving power.

As apparent from the foregoing description, according to the spray nozzle of the present invention, the sectional area of the flow path of the nozzle tip decreases gradually in the range from the inlet port to the throat portion. The sectional area of the flow path in the range from the throat portion to the spray port is constant or decreases gradually. The sectional configuration of said flow path in the range from said inlet port to said throat portion is circular or elliptic. The sectional configuration of said flow path in the range from said the throat portion to near the spray port is elliptic or long ciucular. The throat portion does not have a sharp edge formed thereon but is formed as a surface smoothly continuous with the front and rear portions thereof. Thus water flowing along the flow path of the nozzle tip can be kept in a laminar flow without generating a turbulent flow along the peripheral wall of the nozzle tip at the spray port side. Thus it is possible to prevent the sprayed water from being atomized, reliably maintain the desired thin spray pattern, and make the liquid-driving power uniform and high in the entire spray pattern. Consequently it is possible to increase cleaning effect in a high-pressure cleaning operation and save water.

Since the sharp edge is not formed on the throat portion, it is possible to prevent the distribution of the liquid-driving power from being changed even in a long-time use of the spray nozzle unlike the conventional spray nozzle in which owing to wear of the sharp edge formed on the throat portion, the distribution of the liquid-driving power changes and it is possible to make the maintenance cycle long.

In the case where the flow rectifier is mounted in the adapter, it is possible to prevent water divided and rectified in its flow by the flow rectification plates from becoming turbulent and generating a turbulent flow, when the water flows out from the gap between blades mounted on the flow rectification plates. Thus the water can be supplied to the nozzle tip in a laminar state. Therefore it is possible to thin the spray jetted from the long and narrow spray port and increase the liquid-driving power.

In the case where the spray nozzle is provided with the check valve, the inside of the piston valve of the check valve serves as a flow path. Thus it is possible to form the flow path on the axis of the piston valve without making a detour by bending the flow path extending from the opening/closing valve to the peripheral side. Therefore it is possible to improve the flow rectification effect of flowing water linearly.

Accordingly, water can be supplied to the nozzle as a laminar flow. Thus the flow path of the nozzle tip provides a spray pattern conforming to a designed spray pattern at a uniform distribution of flow rate and the spray can be jetted with a high liquid-driving power.

In addition, since rectification of the liquid flow is accelerated, the flow path does not generate vibrations that will occur when a turbulent flow is generated, thus improving the sealing performance.

The check valve is urged in the direction in which the opening/closing valve of the piston valve closes the valve seat. In dependence on a supplied liquid pressure, the valve seat is opened by pressing down the piston valve against the urging force of the spring. This construction eliminates the need for a particular construction for opening and closing the valve. Thus the check valve has a simple construction.

By simplifying the construction, maintenance can be accomplished easily, and the generation percentage of trouble decreases. Hence it is possible to make the maintenance cycle long. Further since the check valve has a simple construction, it is easy to design and produce it and reduce the cost.

Since the flow path inside the piston valve is straight, it is possible to form a liquid flow having a high linearity in the piston valve and hence a high flow-rectifying effect can be obtained. By making the piston valve long, the flow path of a flow-rectified range is long. Thus the flow rectification effect can be improved further.

Since the flow rectifier having the flow path-partitioning plate is disposed inside the adapter downstream from the piston valve, it is possible to reliably rectify the flow of a liquid again after the liquid is rectified in the flow path of the piston valve.

What is claimed is:

1. A spray nozzle in which a nozzle tip is removably installed on a main body of said spray nozzle at a spray side thereof,
wherein a flow path communicating a spray port disposed on a front-end surface of said nozzle tip with an inlet port disposed at a side opposite to said front-end surface is provided along an axis of said nozzle tip,
a throat portion is provided on said flow path of said nozzle tip in a range from said inlet port to said spray port;
a sectional configuration of said flow path in a range from said inlet port to said throat portion is circular or elliptic, and a sectional area of said flow path decreases gradually from said inlet port to said throat portion;
a sectional configuration of said flow path in a range from said throat portion to said spray port changes from a circular configuration to the elliptic configuration or an elliptic configuration to a long circular configuration, of which a pair of long side are straight line and a pair of short side are arc line, in such a way that said flow path in the range from said throat portion to said spray port is smoothly continuous, and a sectional area of said flow path from said throat portion to said spray port is constant or decreases gradually; and
a ratio of a radius of curvature (R) of said throat portion to a diameter (d) of said flow path at said throat portion is set to: R/d=0.2-5 in such a way that said flow path in the range from said inlet port to said spray port is smoothly continuous to allow a liquid-driving power to be uniform and high in an entire spray pattern.

2. The spray nozzle according to claim 1, wherein a ratio of a minor axis of said spray port to a major axis thereof is set to a range of 1:2 to 1:7, and a ratio of a minor axis of said inlet port to a major axis thereof is set to a range of 1:1 to 1:3.

3. The spray nozzle according to claim 1, wherein supposing that a sectional area of said spray port is 1, a sectional area of a throat portion is 1-4.0 times larger than that of said spray port and a sectional area of said inlet port is 1.4-11 times larger than that of said spray port.

4. The spray nozzle according to claim 1, wherein said nozzle tip and an adapter are removably installed inside said main body thereof; and a strainer is connected to said adapter in such a way that an axis of said nozzle tip, that of said adapter, and that of said strainer align with one another;
a housing of said strainer is open at one end thereof connected to said adapter and is closed at other end thereof to form a closed wall; and a plurality of longitudinal grooves are circumferentially formed at regular intervals on a peripheral surface of said housing from said closed wall thereof to a predetermined position of said peripheral surface thereof in such away that a liquid flows into said housing from said longitudinal grooves; and
said adapter accommodates a flow rectifier having a plurality of flow rectification plates partitioning a flow path inside said adapter connected to said strainer into a plurality of compartments.

5. The spray nozzle according to claim 4, wherein a diameter of a flow path to be formed along said axis of said adapter decreases toward said nozzle tip.

6. The spray nozzle according to claim 1, wherein a strainer to which a liquid is supplied from a liquid supply pipe, a check valve opening and closing a flow path in dependence on a liquid pressure, an adapter incorporating a flow rectifier, and said nozzle tip are sequentially continuously arranged; and a flow path is formed continuously in the form of a straight pipe along the same axis in a range from said strainer disposed at a rear end of said spray nozzle to a spray port of said nozzle tip disposed at a front end thereof, and
said check valve having a hollow piston valve that is urged in a flow path-closing direction by a spring disposed along an inner peripheral surface of a cylinder, an opening/closing valve, for opening and closing a valve seat formed on said cylinder, disposed at a rear end of said piston valve at a liquid inflow side thereof, and at least of an inflow opening formed at a position of a peripheral wall of said piston valve close to said opening/closing valve,
wherein when said opening/closing valve opens said valve seat according to a liquid pressure against an urging force of said spring, a liquid which has flowed into a space between said piston valve and said cylinder flows through said inflow opening and flows into a flow path composed of a hollow portion of said piston valve; and
said flow rectifier is fitted in an inlet port of said adapter, and a comparatively long flow path is formed in a range from said flow rectifier to said inlet port of said nozzle tip.

7. A spray nozzle having a strainer to which a liquid is supplied from a liquid supply pipe, a check valve opening and closing a flow path in dependence on a liquid pressure, an adapter incorporating a flow rectifier, and a nozzle tip are sequentially continuously arranged; said nozzle tip and said adapter are removably installed inside a main body of said spray nozzle; and a flow path is formed continuously in the form of a straight pipe along the same axis in a range from said strainer disposed at a rear end of said spray nozzle to a spray port of said nozzle tip disposed at a front end thereof, and
said check valve having a hollow piston valve that is urged in a flow path-closing direction by a spring disposed along an inner peripheral surface of a cylinder, an opening/closing valve, for opening and closing a valve seat formed on said cylinder, disposed at a rear end of said piston valve at a liquid inflow side thereof, and at least of an inflow opening formed at a position of a peripheral wall of said piston valve close to said opening/closing valve,
wherein when said opening/closing valve opens said valve seat according to a liquid pressure against an urging force of said spring, a liquid which has flowed into a space between said piston valve and said cylinder flows through said inflow opening and flows into a flow path composed of a hollow portion of said piston valve; and
said flow rectifier is fitted in an inlet port of said adapter, and a comparatively long flow path is formed in a range from said flow rectifier to said inlet port of said nozzle tip.

8. The spray nozzle according to claim 6, wherein a diameter d₂ of a flow path inside said check valve and a diameter d₁ of a flow path inside said adapter are set to a relationship of 1≦d₂²/d₁²≦1.4; a ratio of a length L₁ of said flow path inside said adapter to said diameter d₁ of said flow path inside said adapter: L₁/d₁ is set to 3-5; and a ratio of a length L₂ of said flow path inside said check valve to said diameter d₂ of said flow path inside said check valve: L₂/d₂ is set to 3-5.

9. The spray nozzle according to claim 6, wherein a supporting cylindrical portion for said spring is projected at a rear end of said inlet port of said adapter; said piston valve slides on an inner peripheral surface of said supporting cylindrical portion; and said flow rectifier is fitted at a front portion of said adapter continuous with said supporting cylindrical portion.

10. The spray nozzle according to claim 6, wherein a spring receiving seat which projects radially outwardly and makes a close contact with an inner peripheral surface of said cylinder slidably is provided in the vicinity of a rear end of said piston valve at a liquid inflow side thereof; said spring receiving seat confronts said supporting cylindrical portion, for a spring, disposed on said adapter; and said spring receiving seat supports one end of said long spring, while said supporting cylindrical portion supports other end thereof,
a tapered peripheral wall whose diameter decreases in such a way as to form a gap serving as a flow path between said tapered peripheral wall and said inner surface of said cylinder is formed rearward from said spring receiving seat; and inflow openings are circumferentially formed on its tapered peripheral wall at a certain interval spaced therebetween in such a way that said inflow openings are perpendicular to an axial direction of said flow path.

11. The spray nozzle according to claim 6, wherein said flow rectifier interposed between said flow path inside said piston valve and said flow path inside said adapter has a flow path-partitioning plate.

12. The spray nozzle according to claim 6, wherein said check valve is made of brass and said piston valve is made of stainless steel; and said piston valve and said cylinder are made of different materials.

13. The spray nozzle according to claim 6, wherein said strainer disposed continuously with inlet ports of said check valve are composed of a rear end-closed long cylindrical body and has inlet ports disposed axially on its peripheral wall in such a way that said inlet ports are spaced circumferentially at a certain interval spaced therebetween from a peripheral wall thereof; and
said strainer is installed on a water supply pipe in a direction perpendicular to an axial direction in such a way that said strainer projects inward into said water supply pipe, and a liquid which has flowed into an inner flow path from said inlet port flows toward said opening/closing valve disposed at a center of said check valve.

14. The spray nozzle according to claim 4, wherein said strainer is installed on a water supply pipe in a direction perpendicular to an axial direction in such a way that said strainer is disposed alongside said water supply pipe and spaced at a certain interval from said water supply pipe.
